(19) United States
(12) Patent Application Publication
(10) Pub. No.: US 2023/0236414 A1
(43) Pub. Date: Jul. 27, 2023

(54) METASURFACE OPTICAL DEVICE, OPTICAL APPARATUS, PREPARATION METHOD FOR METASURFACE OPTICAL DEVICE

(71) Applicant: Shphotonics Ltd, Suzhou (CN)

(72) Inventors: Bing QIU, Suzhou (CN); Lei SUN, Suzhou (CN)

(21) Appl. No.: 18/157,782

(22) Filed: Jan. 20, 2023

(30) Foreign Application Priority Data
Jan. 24, 2022 (CN) 202210098888.1

(51) Int. Cl. G02B 27/00; G02B 1/00

(52) U.S. Cl. CPC G02B 27/0025; G02B 1/002; G02B 2207/101

(57) ABSTRACT

A metasurface optical device includes a substrate, a nano-structure layer, and a chromatic aberration adjustment layer. The nano-structure layer is formed on a side of the substrate and includes a plurality of nano-structure units. The chromatic aberration adjustment layer includes a stepped structure. The material of the chromatic aberration adjustment layer is different from the substrate material.

### CROSS-REFERENCE TO RELATED APPLICATION

This application claims priority to Chinese Application No. 202210098888.1, filed on Jan. 24, 2022, the entire content of which is incorporated herein by reference.

### TECHNICAL FIELD

The present disclosure relates to the metasurface technology field and, in particular, to a metasurface optical device, an optical apparatus, and a preparation method of the metasurface optical device.

### BACKGROUND

Metasurface refers to an artificial two-dimensional material with the sizes of basic structure units smaller than the working wavelengths and in the order of nanometers. Metasurface can realize flexible and effective control of the characteristics, such as propagation direction, polarization mode, amplitude, and phase, of electromagnetic waves.

Metasurface can make ultra-light, ultra-thin, and multifunctional optical devices. Compared with conventional optical devices, a metasurface optical device manufactured based on semiconductor technology has the advantages of excellent optical performance, small size, and high integration. Metasurface optical devices can be widely used in future portable and miniaturized devices, such as augmented reality wearable devices, virtual reality wearable devices, and mobile terminal lenses.

How to improve the optical performance of metasurface optical devices is an important research direction for those skilled in the art.

### SUMMARY

Embodiments of the present disclosure provide a metasurface optical device, including a substrate, a nano-structure layer, and a chromatic aberration adjustment layer. The nano-structure layer is formed on a side of the substrate and includes a plurality of nano-structure units. The chromatic aberration adjustment layer includes a stepped structure. A material of the chromatic aberration adjustment layer is different from a material of the substrate.

Embodiments of the present disclosure provide an optical apparatus, including a metasurface optical device. The device includes a substrate, a nano-structure layer, and a chromatic aberration adjustment layer. The nano-structure layer is formed on a side of the substrate and includes a plurality of nano-structure units. The chromatic aberration adjustment layer includes a stepped structure. A material of the chromatic aberration adjustment layer is different from a material of the substrate.

Embodiments of the present disclosure provide a preparation method of a metasurface optical device. The method includes forming a nano-structure layer on a side of a substrate. The nano-structure layer includes a plurality of nano-structure units. The method further includes forming a chromatic aberration adjustment layer on at least one of a side of the substrate away from the nano-structure layer or a side of the nano-structure layer away from the substrate. A material of the chromatic aberration adjustment layer is different from a material of the substrate. The chromatic aberration adjustment layer has a stepped structure.

### BRIEF DESCRIPTION OF THE DRAWINGS

FIG. 1 is a schematic diagram showing the principle of chromatic aberration generation when imaging using a lens.

FIG. 2 is a schematic diagram showing the principle of chromatic aberration generation when imaging using a metasurface optical device.

FIG. 3A is a schematic structural diagram showing a cross-section of a metasurface optical device according to some embodiments of the present disclosure.

FIG. 3B is a schematic structural diagram showing a cross-section of a metasurface optical device according to some other embodiments of the present disclosure.

FIG. 4A is a schematic structural diagram showing a cross-section of a metasurface optical device according to some other embodiments of the present disclosure.

FIG. 4B is a schematic structural diagram showing a cross-section of a metasurface optical device according to some other embodiments of the present disclosure.

FIG. 5 is a schematic structural diagram showing a cross-section of a metasurface optical device according to some other embodiments of the present disclosure.

FIG. 6 is a schematic structural diagram showing a cross-section of a metasurface optical device according to some other embodiments of the present disclosure.

FIG. 7A is a schematic diagram showing a square value of an electric field intensity changing with an optical axis after lights of different colors pass through a metasurface optical device.

FIG. 7B is a schematic diagram showing a square value of an electric field intensity changing with an optical axis after lights of different colors pass through a metasurface optical device according to some embodiments of the present disclosure.

FIG. 7C is a schematic diagram showing a square value of an electric field intensity changing with an optical axis after lights of different colors pass through a metasurface optical device according to some other embodiments of the present disclosure.

FIG. 8 is a schematic structural block diagram of an optical apparatus according to some embodiments of the present disclosure.

FIG. 9 is a schematic flowchart of a preparation method of a metasurface optical device according to some embodiments of the present disclosure.

FIG. 10A is a schematic diagram showing a process of a preparation method of a metasurface optical device according to some embodiments of the present disclosure.

FIG. 10B is a schematic diagram showing another process of the preparation method of the metasurface optical device according to some embodiments of the present disclosure.

FIG. 10C is a schematic diagram showing another process of the preparation method of the metasurface optical device according to some embodiments of the present disclosure.

### DETAILED DESCRIPTION OF THE EMBODIMENTS

In the following, some example embodiments are described. As those skilled in the art would recognize, the described embodiments can be modified in various manners, all without departing from the spirit or scope of the present disclosure. Accordingly, the drawings and descriptions are illustrative in nature and not limiting.

In the present disclosure, terms such as “first,” “second,” and “third” can be used to describe various elements, components, regions, layers, and/or parts. However, these elements, components, regions, layers, and/or parts should not be limited by these terms. These terms are only used to distinguish one element, component, region, layer, or part from another element, component, region, layer, or layer. Therefore, a first element, component, region, layer, or part discussed below can also be referred to as a second element, component, region, layer, or part, which does not constitute a departure from the teachings of the present disclosure.

A term specifying a relative spatial relationship, such as “below,” “beneath,” “lower,” “under,” “above,” or “higher,” can be used in the disclosure to describe the relationship of one or more elements or features relative to other one or more elements or features as illustrated in the drawings. These relative spatial terms are intended to also encompass different orientations of the device in use or operation in addition to the orientation shown in the drawings. For example, if the device in a drawing is turned over, an element described as “beneath,” “below,” or “under” another element or feature would then be “above” the other element or feature. Therefore, an example term such as “beneath” or “under” can encompass both above and below. Further, a term such as “before,” “in front of,” “after,” or “subsequently” can similarly be used, for example, to indicate the order in which light passes through the elements. A device can be oriented otherwise (e.g., being rotated by 90 degrees or being at another orientation) while the relative spatial terms used herein still apply. In addition, when a layer is referred to as being “between” two layers, it can be the only layer between the two layers, or there can be one or more intervening layers.

Terminology used in the disclosure is for the purpose of describing the embodiments only and is not intended to limit the present disclosure. As used herein, the terms “a,” “an,” and “the” in the singular form are intended to also include the plural form, unless the context clearly indicates otherwise. Terms such as “comprising” and/or “including” specify the presence of stated features, entities, steps, operations, elements, and/or parts, but do not exclude the existence or addition of one or more other features, integers, steps, operations, elements, parts, and/or combinations thereof. As used herein, the term “and/or” includes any and all combinations of one or more of the listed items. The phrases “at least one of A and B” and “at least one of A or B” mean only A, only B, or both A and B.

When an element or layer is referred to as being “on,” “connected to,” “coupled to,” or “adjacent to” another element or layer, the element or layer can be directly on, directly connected to, directly coupled to, or directly adjacent to the other element or layer, or there can be one or more intervening elements or layers. In contrast, when an element or layer is referred to as being “directly on,” “directly connected to,” “directly coupled to,” or “directly adjacent to” another element or layer, then there is no intervening element or layer. “On” or “directly on” should not be interpreted as requiring that one layer completely covers the underlying layer.

In the disclosure, description is made with reference to schematic illustrations of example embodiments (and intermediate structures). As such, changes of the illustrated shapes, for example, as a result of manufacturing techniques and/or tolerances, can be expected. Thus, embodiments of the present disclosure should not be interpreted as being limited to the specific shapes of regions illustrated in the drawings, but are to include deviations in shapes that result, for example, from manufacturing. Therefore, the regions illustrated in the drawings are schematic and their shapes are not intended to illustrate the actual shapes of the regions of the device and are not intended to limit the scope of the present disclosure.

Unless otherwise defined, all terms (including technical and scientific terms) used herein have the same meaning as commonly understood by those of ordinary skill in the art to which this disclosure belongs. Terms such as those defined in commonly used dictionaries should be interpreted to have meanings consistent with their meanings in the relevant field and/or in the context of this disclosure, unless expressly defined otherwise herein.

As used herein, the term “substrate” can refer to the substrate of a diced wafer, or the substrate of an un-diced wafer. Similarly, the terms “chip” and “die” can be used interchangeably, unless such interchange would cause conflict. The term “layer” can include a thin film, and should not be interpreted to indicate a vertical or horizontal thickness, unless otherwise specified.

A property that a refractive index of a material changes with a frequency of incident light is called “dispersion.” For example, a thin beam of white light can be divided into seven colors of red, orange, yellow, green, blue, indigo, and purple by a prism. This is because the prism has different refractive indices for lights with different wavelengths in a polychromatic light. When the different wavelengths of lights pass through the prism, their propagation directions are deflected to different degrees. Thus, when leaving the prism, the lights with different wavelengths are dispersed respectively.

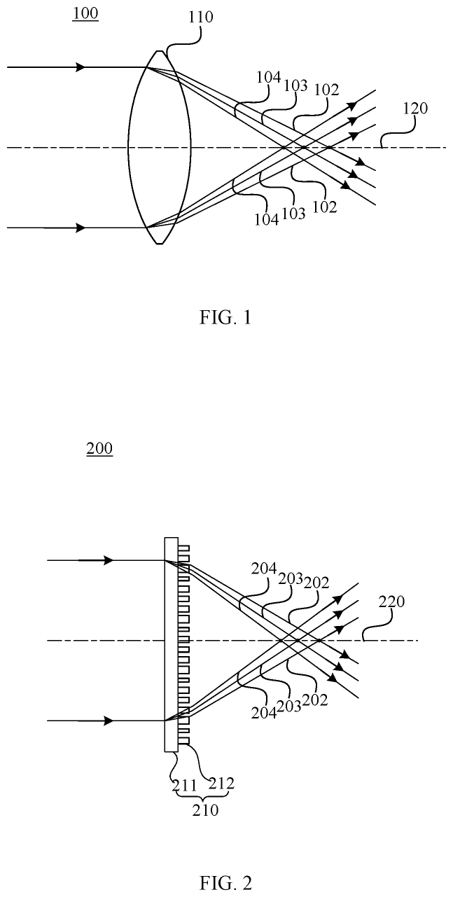

FIG. 1 is a schematic diagram 100 showing the principle of chromatic aberration generation when imaging using a lens 100. When the lens 110 is used to form an image, lights with different colors (red light 102, green light 103, and blue light 104 shown in FIG. 1) form dispersion. Aberration caused by differences in optical lengths and refraction angles of lights with different colors is called chromatic aberration. Optical length can be understood as a distance traveled by light in a vacuum within a same time, which equals a product of a refractive index of a medium and a distance the light propagates in the medium. The chromatic aberration may include a positional chromatic aberration and a magnification chromatic aberration due to different properties. The positional chromatic aberration describes differences in imaging positions of lights with different colors on an optical axis 120 (as shown in FIG. 1), and the magnification chromatic aberration describes differences in image sizes caused by different imaging heights (i.e., magnifications) of lights with different colors. The chromatic aberration significantly affects imaging properties of an optical system. Thus, it is needed to correct the chromatic aberration, such as using a proper combination of converging lens and diverging lens to reduce the chromatic aberration.

FIG. 2 is a schematic diagram 200 showing the principle of chromatic aberration generation when imaging using a metasurface optical device. As shown in FIG. 2, a metasurface optical device 210 includes a substrate 211 and a nano-structure layer 212. The nano-structure layer 212 includes a plurality of columnar nano-structure units. The metasurface optical device 210 has a light converging effect substantially equivalent to that of the lens 110 shown in FIG. 1, and also has the chromatic aberration similar to that shown in FIG. 1. As shown in FIG. 2, when the metasurface optical device 210 is used for imaging, lights with different colors (red light 204, green light 203, and blue light 202 shown in FIG. 2) form the positional chromatic aberration on an optical axis 220.

One solution to correct the chromatic aberration of the metasurface optical device is to attach one or more lens to a back side of the substrate of the metasurface optical device, that is, the side of the substrate facing away from the nano-structure unit, to achieve the effect of reducing the chromatic aberration. However, such a solution requires a very high precision in a lens bonding process. Moreover, limited by a surface shape and a thickness of the lens, an overall structure is more complicated, an overall thickness increases, thereby making it undesirable to be assembled with other structures.

Embodiments of the present disclosure provide a metasurface optical device, an optical apparatus including the metasurface optical device, and a preparation method of the metasurface optical device, to improve the optical performance of the metasurface optical device.

In embodiments of the present disclosure, the metasurface optical device can include a substrate, a nano-structure layer, and at least one chromatic aberration adjustment layer. The nano-structure layer can be formed on a side of the substrate and include a plurality of first nano-structure units. The at least one chromatic aberration adjustment layer can be formed on one or two sides of the substrate. Each chromatic aberration adjustment layer can be made of a material different from the substrate and have a stepped structure. Based on the chromatic aberration adjustment layer, the chromatic aberration caused by the nano-structure layer can be adjusted. For example, the chromatic aberration can be reduced or even enlarged. Designs can be made in connection with the chromatic aberration adjustment to realize other functions, for example, convergence, divergence, and deflection of the light, to improve the optical performance of the metasurface optical device.

In embodiments of the present disclosure, specific product types of the optical apparatus including the metasurface optical device are not limited. For example, the optical apparatus may be a lens of an augmented reality wearable device, a virtual reality wearable device, a mobile terminal, or a spectrometer, a microscope, a telescope, or the like.

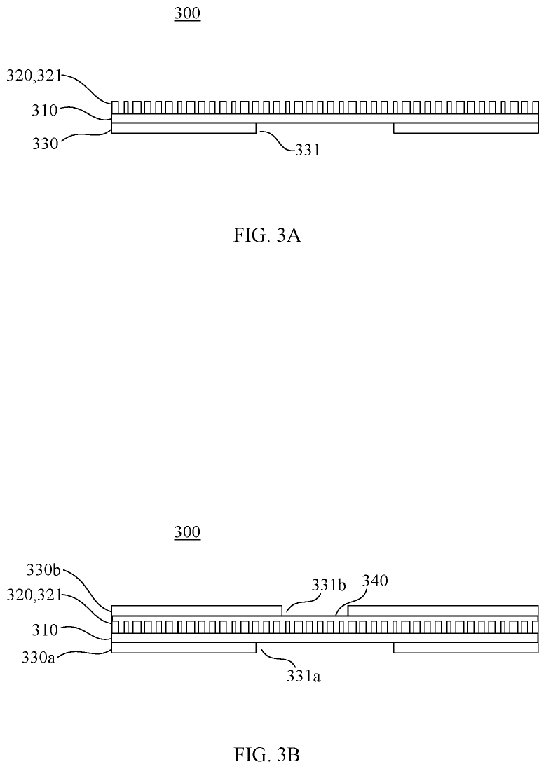

FIG. 3A shows an example of a metasurface optical device 300 consistent with the present disclosure. The metasurface optical device 300 includes a substrate 310, a nano-structure layer 320, and a chromatic aberration adjustment layer 330. The nano-structure layer 320 is formed on a side of the substrate 310. The nano-structure layer 320 includes a plurality of first nano-structure units 321. The metasurface optical device in this example includes one chromatic aberration adjustment layer 330. The chromatic aberration adjustment layer 330 is formed on one side of the substrate away from the nano-structure layer 320. The chromatic aberration adjustment layer 330 and the substrate 310 can be formed of different materials. The chromatic aberration adjustment layer 330 includes a stepped structure 331.

In some embodiments, one side of the metasurface optical device 300 with the nano-structure layer 320 can be used as a light incident side of the metasurface optical device 300, and the other side of the metasurface optical device 300 can be used as a light output side of the metasurface optical device 300. In some other embodiments of the present disclosure, the side of the metasurface optical device 300 without the nano-structure layer 320 can be used as the light incident side of the metasurface optical device 300. The side of the metasurface optical device 300 provided with the nano-structure layer 320 can be used as the light output side of the metasurface optical device 300.

In embodiments of the present disclosure, a material of the substrate 310 is not limited. For example, the material of the substrate 310 can include any one or a combination of glass, quartz, polymer, and plastic.

A material of the nano-structure layer 320 is not limited. For example, the material of the nano-structure layer 320 can include at least one of single crystalline silicon, polycrystalline silicon, amorphous silicon, silicon carbide, titanium dioxide, silicon nitride, germanium, or a group III-V compound semiconductor. The group III-V compound can include a compound formed by boron, aluminum, gallium, indium of group III with nitrogen, phosphorus, arsenic, antimony of group V in the periodic table of elements, for example, gallium phosphide, gallium nitride, gallium arsenide, indium phosphide, etc.

As shown in FIG. 3A, the nano-structure layer 320 includes a plurality of first nano-structure units 321. An interval exists between adjacent first nano-structure units 321. The first nano-structure unit 321 can be a smallest unit of the nano-structure layer 320 configured to control light. A structural size of the first nano-structure unit 321 can be smaller than the working wavelength and can be usually in nanometers. The plurality of first nano-structure units 321 can be arranged two-dimensionally. For example, at least some first nano-structure units 321 can be arranged with reference to a rectangular coordinate system or a polar coordinate system.

In some embodiments of the present disclosure, the plurality of first nano-structure units 321 can be nanopillar units, that is, columnar structures protruding from the substrate 310, as shown in FIG. 3A. In some embodiments of the present disclosure, the plurality of first nano-structure units can also be nanohole units, that is, a plurality of hole structures formed in the nano-structure layer. A shape of the nanopillar or nanohole is not limited and can include, for example, cylinder, square column, rectangular column, concentric cylinder, star-shaped column, etc.

In the example shown in FIG. 3A, since the first nano-structure unit 321 has a material different from a material of the medium (e.g., air) in the interval between the adjacent first nano-structure units 321, refractive indices of the material of the first nano-structure unit 321 and the material of the medium can be different. Phases of the light after passing through the first nano-structure unit 321 and the interval can also be different. At least one parameter such as shape, size, height, period, arrangement, and/or material of different first nano-structure units 321 can be different, which results in different phases of the light passing through different first nano-structure units 321. For example, the light can have a phase delay after passing through the first nano-structure unit 321. By designing a degree of a phase delay caused by each first nano-structure unit of the plurality of first nano-structure units 321, the metasurface optical device 300 can realize a corresponding optical function, for example, a function similar to a converging lens, a diverging lens, or a grating.

In embodiments of the present disclosure, the chromatic aberration adjustment layer 330 can be used to adjust the chromatic aberration caused by the nano-structure layer 320. The chromatic aberration adjustment layer 330 and the substrate 310 can have different materials. The chromatic aberration adjustment layer 330 can be formed on the back side of the substrate 310 through a preparation process. For example, the chromatic aberration adjustment layer 330 can include crown glass or flint glass. The substrate 310 can include fused silica. Usually, optical glass with a dispersion coefficient (i.e., an Abbe number) greater than 50 can be referred to as the crown glass, which is denoted by “K.” Optical glass with the dispersion coefficient less than 50 can be referred to as flint glass, which is denoted by “F.”

Depending on the dispersion requirements of the optical apparatus for the metasurface optical device 300, the chromatic aberration adjustment layer 330 can be used to reduce or increase the chromatic aberration of the metasurface optical device 300. For example, for an imaging lens, the chromatic aberration adjustment layer 330 can be used to reduce the chromatic aberration to improve imaging quality. As another example, for a spectrometer, the chromatic aberration adjustment layer 330 can be used to increase the chromatic aberration to improve the spectral effect and the resolution of the spectrometer.

The principle that the chromatic aberration adjustment layer 330 adjusts the chromatic aberration of the metasurface optical device 300 is as follows. Lights of different colors can have an optical length difference during the propagation in the nano-structure layer 320 because of the difference in the refractive indices, which can result in optical aberration, i.e., chromatic aberration in this case, if the optical length difference is not compensated or corrected. In embodiments of the present disclosure, chromatic aberration can be reduced or increased by designing the chromatic aberration adjustment layer 330. For example, to reduce the chromatic aberration, the optical length difference of the light in the nano-structure layer 320 can be compensated through the stepped structure of the chromatic aberration adjustment layer 330. Thus, a light travelling a longer distance in the nano-structure layer 320 can travel a shorter distance in the chromatic aberration adjustment layer 330, and a light travelling a shorter distance in the nano-structure layer 320 can travel a longer distance in the chromatic aberration layer 330. Therefore, the optical length difference of the lights of different colors passing through the metasurface optical device 300 can be reduced to reduce the chromatic aberration. As another example, to increase the chromatic aberration, the chromatic aberration adjustment layer 330 can be further used to increase the optical length difference of the lights in the nano-structure layer 320 through the design of a shape of the stepped structure 331. Thus, the light travelling a longer distance in the nano-structure layer 320 can also travel a longer distance in the chromatic aberration adjustment layer 330. The light travelling a shorter distance in the nano-structure layer 320 can also travel a shorter distance in the chromatic aberration adjustment layer 330. Thus, the optical length difference of the lights of different colors passing through the metasurface optical device can be increased to increase the chromatic aberration.

In embodiments of the present disclosure, the chromatic aberration adjustment layer 330 of the metasurface optical device 300 can be designed according to the optical apparatus (such as an imaging lens or a spectrometer) employing the metasurface optical device 300 to reduce the chromatic aberration or increase the chromatic aberration. Thus, the optical performance of the metasurface optical device 300 and optical apparatus can be improved.

Human eyes and all other light receivers have a certain sensitivity range. Thus, as long as the chromatic aberration is within an allowable limit, it can be considered ideal from a practical point of view.

Compared with the solution of attaching a lens to the backside of the substrate of the metasurface optical device, in embodiments of the present disclosure, the chromatic aberration adjustment layer 330 can be thinner and flat. Thus, the chromatic aberration adjustment layer 330 can be more beneficial for the miniaturization and ultra-thin design of the device. In addition, compared with the process of attaching a lens, in embodiments of the present disclosure, a lower requirement can be imposed on the preparation process of the chromatic aberration adjustment layer 330, which is beneficial to reduce the manufacturing cost.

In some embodiments of the present disclosure, a material of the nano-structure layer can be a normal dispersion material, and the material of the at least one chromatic aberration adjustment layer can be an anomalous dispersion material. In some other embodiments, the material of the nano-structure layer can be the anomalous dispersion material, and the material of the at least one chromatic aberration adjustment layer can be the normal dispersion material.

For example, in FIG. 3A, the material of one of the nano-structure layer 320 and the chromatic aberration adjustment layer 330 is the normal dispersion material, and the material of the other one of the nano-structure layer 320 and the chromatic aberration adjustment layer 330 is the anomalous dispersion material. The refractive index and dispersion of the normal dispersion material can decrease as the wavelength of the light increases. For example, quartz is a normal dispersion material. A relationship between the refractive index and the wavelength of the anomalous dispersion material can be different from the rule for the normal dispersion material. For example, fluorite is an anomalous dispersion material. The refractive index and dispersion of the fluorite can increase as the wavelength of the light increases.

Based on the structural design of the chromatic aberration adjustment layer 330, in connection with the selection of the above materials, the metasurface optical device 300 can obtain a better chromatic aberration elimination effect. Moreover, the metasurface optical device 300 can be thinner and have higher light transmittance.

In some embodiments of the present disclosure, the materials of the nano-structure layer and the at least one chromatic aberration adjustment layer can be the normal dispersion material, or the materials of the nano-structure layer and the at least one chromatic aberration adjustment layer can be the anomalous dispersion material. For example, in FIG. 3A, the materials of the nano-structure layer 320 and the chromatic aberration adjustment layer 330 are both normal dispersion materials or both anomalous dispersion materials. Based on the structural design of the chromatic aberration adjustment layer 330, with the selection of the materials, the chromatic aberration of the metasurface optical device 300 can be significantly increased. The size of the metasurface optical device can be thinner and have higher light transmittance.

In embodiments of the present disclosure, as shown in FIG. 3A, the stepped structure 331 only includes one step. That is, the chromatic aberration adjustment layer 330 can be flat as a whole and protrude from a surface of the substrate 310 away from the nano-structure layer 320 to form the one step. As shown in FIG. 3A, the chromatic aberration adjustment layer 330 includes a hollow area exposing the substrate 310. An edge of the hollow area can form the one step of the stepped structure 331. The shape, size, and thickness of the chromatic aberration adjustment layer 330 can be designed accordingly in connection with the material selection and a specific optical parameter that the nano-structure layer 320 needs to achieve, which is not limited by the present disclosure.

Through the material selection and structural design of the chromatic aberration adjustment layer 330, the optical structure of the metasurface optical device 300 can be adjusted. The chromatic aberration adjustment layer 330 and the nano-structure layer 320 can jointly determine the optical performance of the metasurface optical device 300.

For example, in some embodiments, the nano-structure layer 320 of the metasurface optical device 300 can be equivalent to a converging lens. The chromatic aberration adjustment layer 330 has the structural design shown in FIG. 3A. In the chromatic aberration adjustment layer 330, there is a hollow area exposing the substrate 310. The edge of the hollow area can be used to form the one step of the stepped structure 331. With such a design, the metasurface optical device 300 can achieve the effect of adjusting and further increasing the chromatic aberration.

As another example, in some embodiments, the nano-structure layer of the metasurface optical device can be equivalent to a converging lens. The stepped structure of the chromatic aberration adjustment layer can include the one step located at the edge of the chromatic aberration adjustment layer. With such a design, the chromatic aberration of the metasurface optical device can be reduced compared with related technologies.

FIG. 3B shows another example of the metasurface optical device 300 consistent with the disclosure. As shown in FIG. 3B, in some embodiments, the metasurface optical device 300 includes the substrate 310, the nano-structure layer 320, a first chromatic aberration adjustment layer 330a, and a second chromatic aberration adjustment layer 330b (i.e., the metasurface optical device 300 shown in FIG. 3B includes two chromatic aberration adjustment layers). The first chromatic aberration adjustment layer 330a can be located on the side of the substrate 310 away from the nano-structure layer 320. The second chromatic aberration adjustment layer 330b can be located on the side of the nano-structure layer 320 away from the substrate 310. In addition, the metasurface optical device 300 further includes a first planarization layer 340 or a first protection layer (the figure shows the first planarization layer) between the nano-structure layer 320 and the second chromatic aberration adjustment layer 330b.

The structures, materials, and optical functions of the first chromatic aberration adjustment layer 330a and the second chromatic aberration adjustment layer 330b can be the same or different. With the design of the first chromatic aberration adjustment layer 330a and the second chromatic aberration adjustment layer 330b, the chromatic aberration caused by the nano-structure layer 320 can be adjusted. For example, the chromatic aberration can be reduced or even increased. Designs can be made for some other functions in connection with the adjustment of the chromatic aberration, for example, convergence, divergence, and deflection of light, to improve the optical performance of the metasurface optical device.

In some embodiments, the first chromatic aberration adjustment layer 330a is similar to the chromatic aberration adjustment layer 330 of example shown in FIG. 3A. The first chromatic aberration adjustment layer 330a and the chromatic aberration adjustment layer 330 are both formed on a side of the substrate 310 away from the nano-structure layer 320. In some other embodiments of the present disclosure, the metasurface optical device 300 can include the second chromatic aberration adjustment layer 330b but not the first chromatic aberration adjustment layer 330a.

A number of the chromatic aberration adjustment layers included in the metasurface optical device is not limited by embodiments of the present disclosure. For example, the metasurface optical device can include three or more chromatic aberration adjustment layers, which can be formed on one or two sides of the substrate. The chromatic aberration adjustment layers can be used to implement corresponding functions, improve the optical performance of the metasurface optical device in connection with the design, or cause the metasurface optical device to implement some expected optical functions.

In some embodiments of the present disclosure, the at least one chromatic aberration adjustment layer can be a separate assembled structure layer. That is, the at least one chromatic aberration adjustment layer can be formed separately, and each of the at least one chromatic aberration adjustment layer can be an independent member, which can be fixed together with other members of the metasurface optical device through assembly. For example, the chromatic aberration adjustment layer can be attached to the side of the substrate away from the nano-structure layer.

In some other embodiments of the present disclosure, the at least one chromatic aberration adjustment layer can also be a process prepared layer. That is, the chromatic aberration adjustment layer can be formed on a surface of a structural layer and attached to the surface through a preparation process. For example, the chromatic aberration adjustment layer with a certain structure can be formed on the side of the substrate away from the nano-structure layer through a patterning process. After being formed, the chromatic aberration adjustment is firmly connected to the substrate and not easy to be separated.

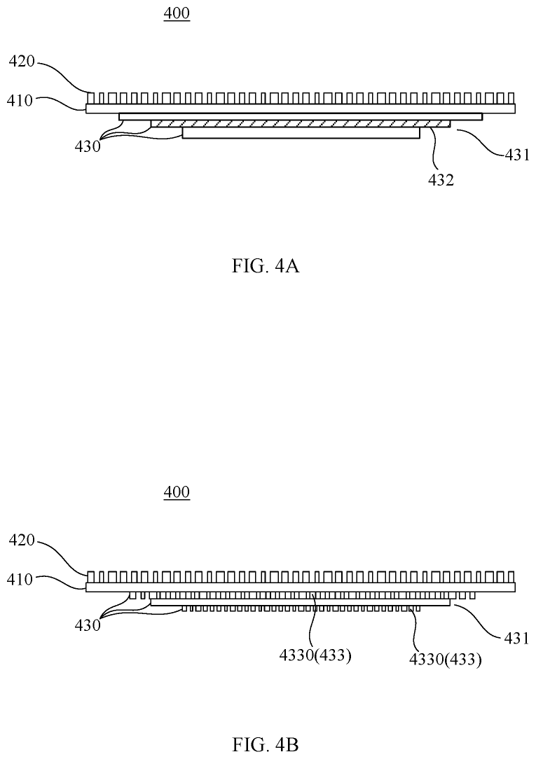

In some embodiments, a stepped structure of a chromatic aberration adjustment layer can include at least two steps. FIG. 4A shows an example of a metasurface optical device 400 consistent with the disclosure. As shown in FIG. 4A, the metasurface optical device 400 includes a substrate 410, a nano-structure layer 420, and a chromatic aberration adjustment layer 430. A stepped structure 431 of the chromatic aberration adjustment layer 430 includes at least two steps. The at least two steps can be located at an edge of the chromatic aberration adjustment layer 430 or an edge of a hollow area of the chromatic aberration adjustment layer 430. In the example shown in FIG. 4A, an edge of an orthogonal projection of the chromatic aberration adjustment layer 430 on the substrate 410 is at an inner side of the edge of the substrate 410. The edge of the chromatic aberration adjustment layer 430 is formed into three steps of the stepped structure 431. With such a design of the chromatic aberration adjustment layer 430, the metasurface optical device 400 can also achieve the effect of decreasing the chromatic aberration or increasing the chromatic aberration. In addition, the design of the at least two steps is equivalent to jagging and discretizing a smooth curved surface of a lens. Then, with the chromatic aberration adjustment layer, the metasurface optical device 400 can achieve a similar effect as a converging lens or a diverging lens. In addition, an optical length of the light can transit smoothly between an area with the chromatic aberration adjustment layer 430 and an area without the chromatic aberration adjustment layer 430.

In the example shown in FIG. 4A, the at least two steps of the chromatic aberration adjustment layer 430 are located at the edge of the chromatic aberration adjustment layer 430. A thickness of a center area of the chromatic aberration adjustment layer 430 is greater than a thickness of an edge area of the chromatic aberration adjustment layer 430. Thus, the chromatic aberration adjustment layer 430 can have a light converging ability. Then, the chromatic aberration adjustment layer 430 can be equivalent to a converging lens. When the nano-structure layer 420 is also equivalent to a converging lens, the chromatic aberration generated after the light passes through the metasurface optical device 400 can be reduced.

In some embodiments, the chromatic aberration adjustment layer can include at least two sub-layers arranged in sequence along a direction away from the substrate and forming the at least two steps. As shown in FIG. 4A, in some embodiments, the chromatic aberration adjustment layer 430 includes at least two sub-layers (three sub-layers are shown in the figure and are only for illustration, and more sub-layers can be included in actual applications). The at least two sub-layers can be arranged in sequence along a direction away from the substrate 410 and form the at least two steps. Materials of the at least two sub-layers can be completely the same or not completely the same. Thicknesses of the at least two sub-layers can be completely the same or not completely the same. By appropriately selecting the materials and thicknesses for the sub-layers, in connection with the design of the stepped structure 431, a finer chromatic aberration adjustment effect can be achieved, a higher transmittance can be obtained, and the metasurface optical device 400 can be even thinner.

In some embodiments of the present disclosure, as shown in FIG. 4A, at least one sub-layer of the at least two sub-layers of the chromatic aberration adjustment layer 430 is a grating sub-layer 432. By forming the grating sub-layer 432 in the chromatic aberration adjustment layer 430, the metasurface optical device 400 can integrate a grating function design. For example, the grating sub-layer 432 can be a transmissive grating sub-layer, a reflective grating sub-layer, a diffractive grating sub-layer, a holographic grating sub-layer, an orthogonal grating sub-layer, a phase grating sub-layer, a blazed grating sub-layer, a stepped grating sub-layer, a naked-eye 3D grating sub-layer, etc. The dispersion of the grating sub-layer 432 can be normal dispersion or anomalous dispersion, which can reduce or increase the dispersion of the device.

As shown in FIG. 4A, each of the sub-layers of the chromatic aberration adjustment layer 430 is a sub-layer of a uniform material and is in a flat plate shape as a whole.

FIG. 4B shows another example of the metasurface optical device 400 consistent with the disclosure. As shown in FIG. 4B, in some embodiments of the present disclosure, at least one of the at least two sub-layers of the chromatic aberration adjustment layer 430 is a nano-structure sub-layer 433 including a plurality of second nano-structure units 4330. FIG. 4B only shows, as an example, a structure that the chromatic aberration adjustment layer 430 includes two nano-structure sub-layers 433. In some other embodiments of the present disclosure, the sub-layers of the chromatic aberration adjustment layer 430 can all be the nano-structure sub-layers 433.

An operation principle of the second nano-structure unit 4330 can be similar to that of the first nano-structure unit and is not repeated here. By designing a degree of phase delay caused by each second nano-structure unit of the plurality of second nano-structure units 4330, the sub-layers can realize corresponding optical functions. Thus, the optical functions of the chromatic aberration adjustment layer 430, for example, chromatic aberration adjustment, and convergence, divergence, and deflection of light, can be easier to realize with a better effect.

When the chromatic aberration adjustment layer 430 includes two or more nano-structure sub-layers 433, parameters such as size, arrangement, and material of the second nano-structure units 4330 of the nano-structure sub-layers 433 can be the same or different. For example, as shown in FIG. 4B, in some embodiments, the second nano-structure units 4330 of the two nano-structure sub-layers 433 of the chromatic aberration adjustment layer 430 are staggered in a direction perpendicular to the substrate 410 and have different sizes and arrangements. In some other embodiments, at least some of the second nano-structure units of the two nano-structure sub-layers of the chromatic aberration adjustment layer can overlap with each other in the direction perpendicular to the substrate.

In some embodiments, the chromatic aberration adjustment layer can include a plurality of sub-layers. A chromatic aberration adjustment layer can be equivalent to a Fresnel lens. The stepped structure of the chromatic aberration adjustment layer can be equivalent to a sawtooth structure of the Fresnel lens. Use of stepped structure equivalent to the sawtooth structure of a Fresnel lens can enable the chromatic aberration adjustment layer to realize an effect of a Fresnel lens. Each sub-layer can be a sub-layer of uniform material or adopt a design similar to the design of the nano-structure sub-layer shown in FIG. 4B.

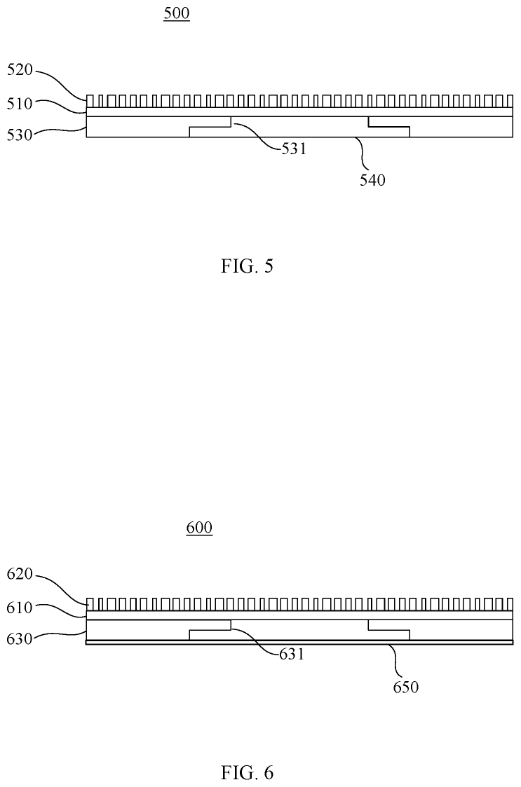

FIG. 5 shows a metasurface optical device 500 consistent with the disclosure. The metasurface optical device 500 includes a substrate 510, a nano-structure layer 520, and a chromatic aberration adjustment layer 530. A stepped structure 531 of the chromatic aberration adjustment layer 530 is located at an edge of a hollow area of the chromatic aberration adjustment layer 530. A thickness of a center area of the chromatic aberration adjustment layer 530 can be smaller than a thickness of an edge area of the chromatic aberration adjustment layer 530 (the thickness of the center area of the chromatic aberration adjustment layer 530 is, for example, zero). Thus, the chromatic aberration adjustment layer 530 can have a light divergence capability. Then, the chromatic aberration adjustment layer 530 can be equivalent to a diverging lens. When the nano-structure layer 520 is equivalent to a converging lens, with the design of the chromatic aberration adjustment layer 530, the chromatic aberration generated by light passing through the metasurface optical device 500 can be adjusted to be increased.

As shown in FIG. 5, in some embodiments of the present disclosure, the metasurface optical device 500 further includes a second planarization layer 540 formed on the side of the chromatic aberration adjustment layer 520 away from the substrate 510. The second planarization layer 540 can cover the stepped structure 531 of the chromatic aberration adjustment layer 530.

The second planarization layer 540 can fill a recess formed by the stepped structure 531. Thus, the second planarization layer 540 not only can protect the structure of the chromatic aberration adjustment layer 530 from being damaged but also can form a flat surface with the chromatic aberration adjustment layer 530, making it easier to attach or assemble the chromatic aberration adjustment layer 530 with another structure. The second planarization layer 540 can be made of a material with a relatively high light transmittance, e.g., silicon carbide, silicon nitride, or resin.

FIG. 6 shows a metasurface optical device 600 consistent with the disclosure. As shown in FIG. 6, in some embodiments of the present disclosure, the metasurface optical device 600 includes a substrate 610, a nano-structure layer 620, a chromatic aberration adjustment layer 630, a second protection layer 650 formed on a side of the chromatic aberration adjustment layer 630 away from the substrate 610. The second protection layer 650 can be formed to provide a hollow chamber between the second protection layer 650 and the stepped structure 631.

The second protection layer 650 can protect the structure of the chromatic aberration adjustment layer 630 from being damaged and can be conveniently attached to or assembled with another structure. The second protection layer 650 can be made of a material with a relatively high light transmittance, such as silicon carbide, silicon nitride, or resin.

In embodiments of the present disclosure, in addition to the layers described above, the metasurface optical device can further include some other optical structure layers. For example, in some embodiments, the metasurface optical device can also include a Fresnel lens layer or a grating layer. These optical structure layers and the first nano-structure layer can be formed on the same side of the substrate or two sides of the substrate.

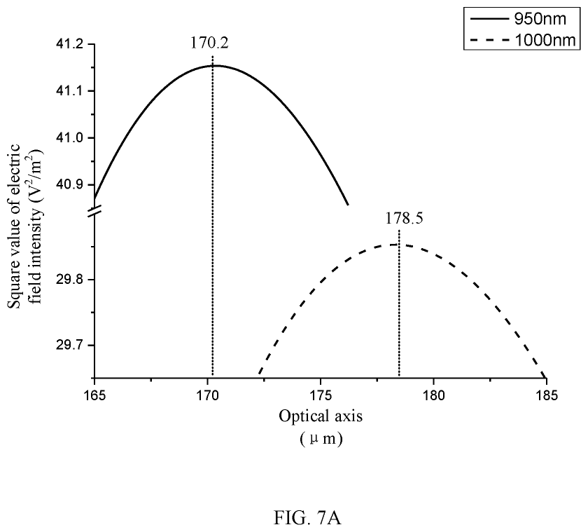

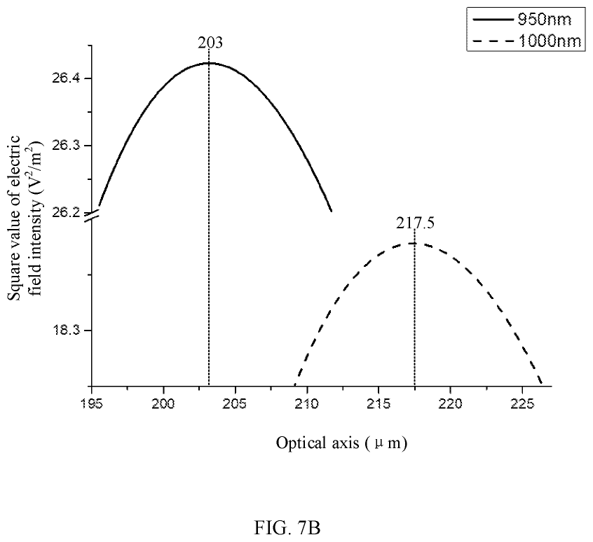

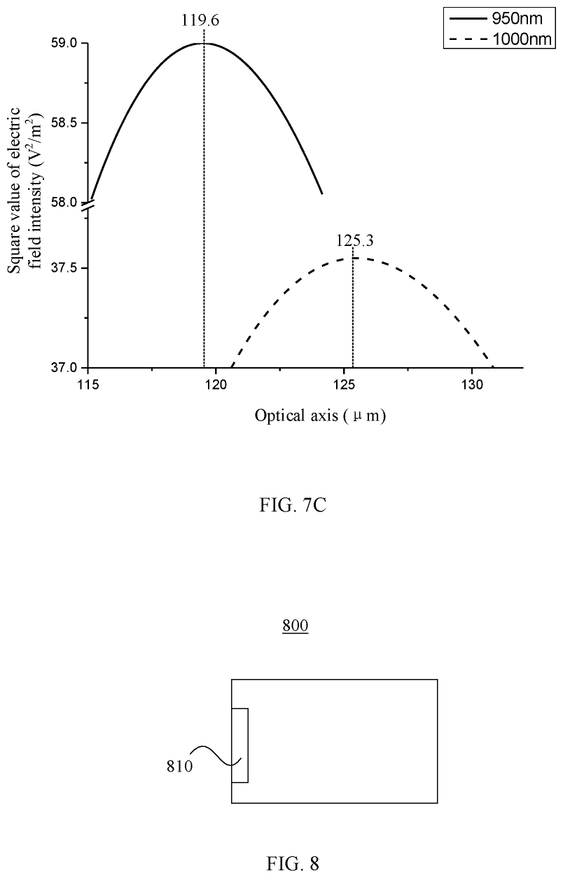

FIG. 7A is a schematic diagram showing a square value of an electric field intensity changing with an optical axis after lights of different colors pass through a metasurface optical device. The metasurface optical device does not adopt any chromatic aberration compensation design. Peaks of curves of lights of two colors (wavelength of 950 nm and wavelength of 1000 nm, respectively) are separated by 8.3 microns along an optical axis. The chromatic aberration is obvious.

FIG. 7B is a schematic diagram showing a square value of an electric field intensity changing with an optical axis after lights of different colors pass through a metasurface optical device according to some embodiments of the present disclosure. The metasurface optical device of embodiments of the present disclosure can include a chromatic aberration adjustment layer formed on a side of a substrate away from a nano-structure layer and including two steps at an edge of a hollow area of the chromatic aberration adjustment layer. Peaks of curves of lights of two colors (wavelength of 950 nm and wavelength of 1000 nm, respectively) are separated by 14.5 microns along an optical axis. The chromatic aberration is further increased compared to FIG. 7A.

FIG. 7C is a schematic diagram showing a square value of an electric field intensity changing with an optical axis after lights of different colors pass through a metasurface optical device according to some other embodiments of the present disclosure. The metasurface optical device of embodiments of the present disclosure can include a chromatic aberration adjustment layer. The chromatic aberration adjustment layer can be formed on a side of a substrate away from a nano-structure layer and include two steps. The two steps can be located at an edge of the chromatic aberration adjustment layer. Peaks of curves of lights of two colors (wavelength of 950 nm and wavelength 1000 nm, respectively) are separated by 5.7 microns along an optical axis. The chromatic aberration is significantly reduced compared to FIG. 7A.

FIG. 8 shows an optical apparatus 800 consistent with the disclosure. As shown in FIG. 8, the optical apparatus 800 includes a metasurface optical device 810. The metasurface optical device 810 can be a metasurface optical device consistent with the disclosure, such as any of the example metasurface optical devices described above. A specific product type of the optical apparatus 800 is not limited. For example, the optical apparatus 800 can include a lens of an augmented reality wearable apparatus, a virtual reality wearable apparatus, or a mobile terminal, or a spectrometer, a microscope, or a telescope. Since the optical performance of the metasurface optical device 810 is improved, the optical apparatus 800 can also have a better optical performance.

Embodiments of the present disclosure also provide a preparation method for a metasurface optical device. The method includes the following processes.

A nano-structure layer is formed on a side of a substrate. The nano-structure layer includes a plurality of first nano-structure units.

A chromatic aberration adjustment layer is correspondingly formed on a side of the substrate away from the nano-structure layer and/or on a side of the nano-structure layer away from the substrate. A material of the chromatic aberration adjustment layer is different from a material of the substrate. The chromatic aberration adjustment layer includes a stepped structure.

The chromatic aberration adjustment layer can be formed on one side or two sides of the substrate. With the chromatic aberration adjustment layer, the chromatic aberration caused by the nano-structure layer can be adjusted. For example, the chromatic aberration can be reduced or even increased. In connection with chromatic aberration adjustment, design can be made for other functions, for example, convergence, divergence, and deflection of light, to improve the optical performance of the metasurface optical device.

In addition, the thickness of the chromatic aberration adjustment layer can be made thinner in the above method, which is beneficial to the miniaturization and ultra-thin design of the device. Compared with the process of attaching a lens, in embodiments of the present disclosure, a relatively low requirement is imposed on the preparation process of the chromatic aberration adjustment layer, which is beneficial to reducing the manufacturing cost.

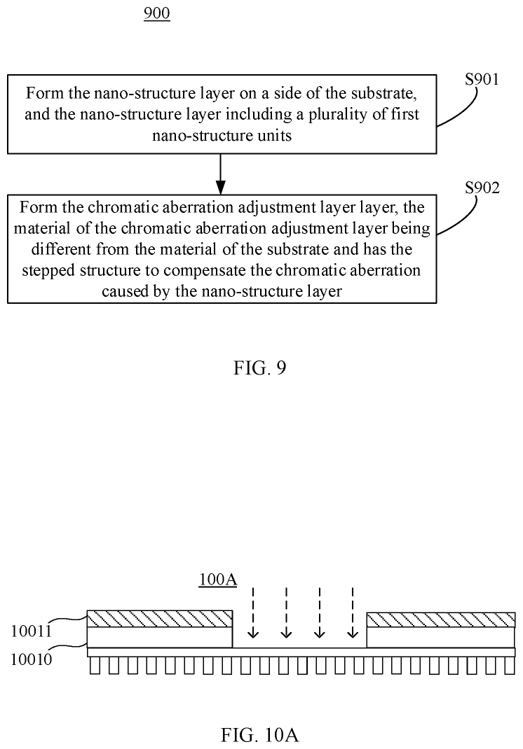

FIG. 9 shows a method forming the chromatic aberration adjustment layer on the side of the substrate away from the nano-structure layer, consistent with the disclosure. The method includes the following processes S901 and S902.

At S901, the nano-structure layer is formed on a side of the substrate, and the nano-structure layer includes a plurality of first nano-structure units.

At S902, the chromatic aberration adjustment layer is formed on the side of the substrate away from the nano-structure layer. The material of the chromatic aberration adjustment layer is different from the material of the substrate and has the stepped structure to compensate the chromatic aberration caused by the nano-structure layer.

Orders of processes S901 and S902 can be interchanged. For example, the chromatic aberration adjustment layer can be formed on one side of the substrate first, and then the nano-structure layer can be formed on the other side of the substrate.

In some embodiments, forming the chromatic aberration adjustment layer includes forming a chromatic aberration adjustment material layer on the side of the substrate away from the nano-structure layer and performing etching (e.g., photolithography) on the chromatic aberration adjustment material layer to form the chromatic aberration adjustment layer having the stepped structure.

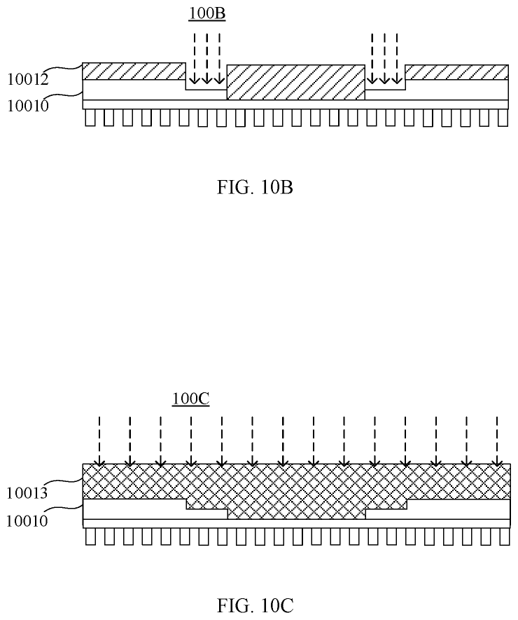

An example process of forming the chromatic aberration adjustment layer shown in FIG. 5 is described below in connection with FIGS. 10A and 10B. First, the chromatic aberration adjustment material layer is formed on the side of the substrate away from the nano-structure layer, a first photosensitive layer is formed on a side of the chromatic aberration adjustment material layer away from the nano-structure layer, a first mask is used to perform exposure on the first photosensitive layer, development is performed on the exposed first photosensitive layer. The first photosensitive layer left on a surface of the chromatic aberration adjustment material layer after the development is used as a first protection mask. Then, as shown in FIG. 10A, at process 100A, etching is performed on the chromatic aberration adjustment material layer 10010 using the first protection mask 10011. Then, the first protection mask is removed to form a first pattern of the chromatic aberration adjustment material layer. Then, a second photosensitive layer is formed on a side of the chromatic aberration adjustment material layer away from the nano-structure layer. Then, exposure is performed on the second photosensitive layer using a second mask. Then, development is performed on the exposed photosensitive layer. The second photosensitive layer left on the surface of the chromatic aberration adjustment material layer after the development is used as a second protection mask. Then, as shown in FIG. 10B, at 100B, etching is performed on the chromatic aberration adjustment material layer 10010 using the second protection mask 10012. Then, the second protection mask is removed to form a second pattern of the chromatic aberration adjustment material layer, that is the chromatic aberration adjustment layer.

In some embodiments, forming the chromatic aberration adjustment layer includes forming the chromatic aberration adjustment material layer on the side of the substrate away from the nano-structure layer and performing embossing on the chromatic aberration adjustment material layer to form the chromatic aberration adjustment layer with the stepped structure.

Another example process of forming the chromatic aberration adjustment layer shown in FIG. 5 is described below in connection with FIG. 10C. First, the chromatic aberration adjustment material layer is formed on the side of the substrate away from the nano-structure layer. Then, as shown in FIG. 10C, at 100C, the chromatic aberration adjustment material layer 10010 is compressed by using a convex emboss 10013. The convex emboss 10013 can have a convex-concave structure corresponding to the stepped structure. After the pattern of the chromatic aberration adjustment material layer is cured, the convex emboss can be removed. That is, the chromatic aberration adjustment layer can be formed on the back side of the substrate.

In the method of some embodiments of the present disclosure, forming the chromatic aberration adjustment layer on the side of the nano-structure layer away from the substrate includes forming the first planarization layer or the first protection layer on the side of the nano-structure layer facing away from the substrate and forming the chromatic aberration adjustment layer on a side of the first planarization layer or the first protection layer away from the substrate.

When the chromatic aberration adjustment layers need to be formed on two sides of the substrate, a chromatic aberration adjustment layer can be formed on a side first according to the method of embodiments of the present disclosure, and then, a chromatic aberration adjustment layer can be formed on the other side.

In some embodiments of the present disclosure, the preparation method of the metasurface optical device further includes forming a second planarization layer on the side of the chromatic aberration adjustment layer away from the substrate. The second planarization layer can cover the stepped structure. The second planarization layer can be used to protect the structure of the chromatic aberration adjustment layer from being damaged and form a flat surface with the chromatic aberration adjustment layer. Thus, the chromatic aberration adjustment layer can be conveniently attached to or assembled with another structure. The second planarization layer can be made of a material with a relatively high light transmittance, for example, silicon carbide, silicon nitride, or resin.

In some embodiments, the preparation method of the metasurface optical device further includes forming the second protection layer on the side of the aberration adjustment layer away from the substrate. The second protection layer can be formed to provide the hollow chamber between the second protection layer and the stepped structure. The second protection layer can be used to protect the structure of the chromatic aberration adjustment layer from being damaged and can be conveniently attached to or assembled with another structure. The second protection layer can be made of a material with a relatively high light transmittance, such as silicon carbide, silicon nitride, or resin.

Consistent with the disclosure, a chromatic aberration adjustment layer can be formed on one or two sides of a substrate. The chromatic aberration adjustment layer can have a stepped structure. Based on the chromatic aberration adjustment layer, the chromatic aberration caused by the nano-structure can be adjusted. For example, the chromatic aberration can be reduced or increased. Moreover, in connection with the chromatic aberration adjustment, designs can be made for other functions, such as convergence, divergence, and deflection of light. Thus, the optical performance of the metasurface optical device can be improved.

Several different embodiments or examples are described in the present disclosure. These embodiments or examples are exemplary and are not intended to limit the scope of the present disclosure. Those skilled in the art can conceive of various modifications or substitutions based on the disclosed contents, and such modifications and substitutions should be included in the scope of the present disclosure. A true scope and spirit of the invention are indicated by the following claims.

What is claimed is:

1. A metasurface optical device comprising:
a substrate;
a nano-structure layer formed on a side of the substrate and including a plurality of nano-structure units; and
a chromatic aberration adjustment layer including a stepped structure, a material of the chromatic aberration adjustment layer being different from a material of the substrate.

2. The metasurface optical device of claim 1, wherein the chromatic aberration adjustment layer is formed on a side of the substrate away from the nano-structure layer.

3. The metasurface optical device of claim 1,
wherein the chromatic aberration adjustment layer is formed on a side of the nano-structure layer away from the substrate;
the metasurface optical device further comprising:
a planarization layer or a protection layer formed between the nano-structure layer and the chromatic aberration adjustment layer.

4. The metasurface optical device of claim 1, wherein the chromatic aberration adjustment layer is a separate assembled structure layer or a process prepared layer.

5. The metasurface optical device of claim 1, wherein the stepped structure includes at least two steps.

6. The metasurface optical device of claim 5, wherein the chromatic aberration adjustment layer includes at least two sub-layers arranged in sequence along a direction away from the substrate and forming the at least two steps.

7. The metasurface optical device of claim 6, wherein at least two of the at least two sub-layers have different materials and/or thicknesses.

8. The metasurface optical device of claim 6, wherein at least one of the at least two sub-layers includes a grating sub-layer.

9. The metasurface optical device of claim 6, wherein:
the plurality of nano-structure units are a plurality of first nano-structure units; and
at least one of the at least two sub-layers includes a nano-structure sub-layer including a plurality of second nano-structure units.

10. The metasurface optical device of claim 1, wherein a thickness of a center area of the chromatic aberration adjustment layer is greater than a thickness of an edge area of the chromatic aberration adjustment layer.

11. The metasurface optical device of claim 1, wherein a thickness of a center area of the chromatic aberration adjustment layer is smaller than a thickness of an edge area of the chromatic aberration adjustment layer.

12. The metasurface optical device of claim 1, wherein:
one of the nano-structure layer and the chromatic aberration adjustment layer includes a normal dispersion material; and
another one of the nano-structure layer and the chromatic aberration adjustment layer includes an anomalous dispersion material.

13. The metasurface optical device of claim 1, wherein:
each of the nano-structure layer and the chromatic aberration adjustment layer includes a normal dispersion material; or
each of the nano-structure layer and the chromatic aberration adjustment layer includes an anomalous dispersion material.

14. The metasurface optical device of claim 1, further comprising:
a planarization layer formed on a side of the chromatic aberration adjustment layer away from the substrate, the planarization layer covering the stepped structure; or
a protection layer formed on the side of the chromatic aberration adjustment layer away from the substrate, a hollow chamber being formed between the protection layer and the stepped structure.

15. An optical apparatus comprising a metasurface optical device including:
a substrate;
a nano-structure layer formed on a side of the substrate and including a plurality of nano-structure units; and
a chromatic aberration adjustment layer including a stepped structure, a material of the chromatic aberration adjustment layer being different from a material of the substrate.

16. The optical apparatus of claim 15, wherein the chromatic aberration adjustment layer is formed on a side of the substrate away from the nano-structure layer.

17. A preparation method of a metasurface optical device comprising:
forming a nano-structure layer on a side of a substrate, the nano-structure layer including a plurality of nano-structure units; and
forming a chromatic aberration adjustment layer on at least one of a side of the substrate away from the nano-structure layer or a side of the nano-structure layer away from the substrate, a material of the chromatic aberration adjustment layer being different from a material of the substrate, and the chromatic aberration adjustment layer having a stepped structure.

18. The method of claim 17, wherein forming the chromatic aberration adjustment layer includes:
forming a chromatic aberration adjustment material layer; and
performing etching or embossing on the chromatic aberration adjustment material layer to form the chromatic aberration adjustment layer with the stepped structure.

19. The method of claim 17, further comprising:
forming a planarization layer or a protection layer on the side of the nano-structure layer away from the substrate;
wherein forming the chromatic aberration adjustment layer on the side of the nano-structure layer away from the substrate includes:
forming the chromatic aberration adjustment layer on a side of the planarization layer or the protection layer away from the substrate.

20. The method of claim 17, further comprising:
forming a planarization layer on a side of the chromatic aberration adjustment layer away from the substrate, the planarization layer covering the stepped structure; or
forming a protection layer on the side of the chromatic aberration adjustment layer away from the substrate, a hollow chamber being formed between the protection layer and the stepped structure.
